(19) United States
(12) Patent Application Publication
(10) Pub. No.: US 2024/0037540 A1
(43) Pub. Date: Feb. 1, 2024

(54) EMPTY SELF-CONTROL CARD SYSTEM AND OPERATION METHOD THEREOF

(71) Applicants: Kenneth Chin Kim, West Covina, CA (US); Kwang Il Kim, Seoul (KR); Jin Hyun KIM, Seoul (KR)

(72) Inventors: Kenneth Chin KIM, West Covina, CA (US); Kwang Il KIM, Seoul (KR); Jin Hyun KIM, Seoul (KR)

(73) Assignees: Kenneth Chin KIM, West Covina, CA (US); Kwang Il KIM, Seoul (KR); Jin Hyun KIM, Seoul (KR)

(21) Appl. No.: 17/875,898

(22) Filed: Jul. 28, 2022

(51) Int. Cl. G06Q 20/36; G06Q 20/10; G06Q 20/06

(52) U.S. Cl. CPC G06Q 20/3676; G06Q 20/105; G06Q 20/0655

(57) ABSTRACT

An empty self-control card system and an operation method thereof are proposed. The empty self-control card system includes a bank server communicatively connected to a CBDC network and configured to open a CBDC account for storing CBDC coins, and an Empty Card linked to the CBDC account and issued as a physical card, and configured to hold the CBDC coins as a balance, wherein the CBDC network transfers at least a portion of the balance of the Empty Card when a transaction using the Empty Card occurs, so that intangible CBDCs that do not exist may be used in real life.

### BACKGROUND OF THE INVENTION

### Field of the Invention

The present disclosure relates to an empty self-control card system and an operation method thereof.

### Description of the Related Art

Central bank digital currency (CBDC) is an electronic form of money issued by a central bank. The central bank digital currency is being discussed after the advent of Bitcoin, which is based on blockchain technology. Bitcoin has various problems, such as difficulty in quick transaction, power consumption, and misuse as a payment means for illegal activities based on anonymity. The central bank digital currency may be introduced as currency that is manageable by countries and solves the problems of Bitcoin.

However, the central bank digital currency does not exist in a physical thing, unlike currencies used as conventional banknotes. Accordingly, it is necessary to develop a system for using the central bank digital currency in real life.

### SUMMARY OF THE INVENTION

An exemplary embodiment of the present disclosure may provide an empty self-control card system as a means for using central bank digital currency (hereinafter referral to as CBDC) for payment in real life. In the present document, an empty self-control card may be abbreviated as an “Empty Card” and may also be referred to as an “ESC Card”.

An empty self-control card system according to the exemplary embodiment of the present disclosure includes: a bank server communicatively connected to a CBDC network and configured to open a CBDC account for storing CBDC coins; and an Empty Card linked to the CBDC account and issued as a physical card, and configured to hold the CBDC coins as a balance, wherein the CBDC network transfers at least a portion of the balance of the Empty Card when a transaction using the Empty Card occurs.

According to the exemplary embodiment, the Empty Card may be issued as the physical card including a card number and a name in response to an issuance request of an account holder, the name included in the Empty Card may be a name of a card user who uses the Empty Card, and the card user may be the same as or different from the account holder.

According to the exemplary embodiment, the bank server may not perform examination on whether the empty card is issued to a person whose name is included in the Empty Card, but may only confirm empty card issuance qualifications of the account holder and determines to issue the Empty Card.

According to the exemplary embodiment, one or more Empty Cards may be issued and linked to the CBDC account of the account holder, and the card user may be authorized to perform transactions in a range of the balance transferred to the Empty Card.

According to the exemplary embodiment, when the account holder connects to the bank server through a user terminal, the bank server may provide a function of managing the CBDC account and one or more Empty Cards linked to the CBDC account.

According to the exemplary embodiment, when the account holder connects to the bank server through the user terminal, the bank server may provide functions of transferring the coins of the CBDC account to the Empty Card and recovering the balance of the coins of the Empty Card to the CBDC account.

The exemplary embodiment of the present disclosure may provide an operation method of an empty self-control card system as a method for using a central bank digital currency (hereinafter referred to as CBDC) for payment in real life.

An operation method of an empty self-control card system according to the exemplary embodiment of the present disclosure includes: receiving, by a bank server, a transaction request using an Empty Card having a balance of CBDC coins; confirming, by the bank server, whether the balance required for a transaction exists in the Empty Card; requesting, by the bank server, to a CBDC network to transfer a portion of the balance existing in the Empty Card; and transferring the coins by the CBDC network.

The operation method of the empty self-control card system according to the exemplary embodiment may further include: receiving, by the bank server, an issuance request of the Empty Card linked to a CBDC account of an account holder from a user terminal; and determining, by the bank server, issuance of the Empty Card by examining only whether the account holder is entitled to issue the Empty Card without examining a name written in card user information included in the issuance request.

According to the exemplary embodiment, the transaction request may be received from any one of a store terminal configured to read the Empty Card and request payment, an ATM configured to request a cash-out using the Empty Card, a user terminal configured to request a remittance of the portion of the balance in the capacity of a card user of the Empty Card, and a user terminal configured to request a remittance of the portion of the balance of the Empty Card in the capacity of an account holder of a CBDC account linked to the Empty Card.

The operation method of the empty self-control card system according to the exemplary embodiment may further include: confirming, by the bank server, transaction details, wherein all the transaction details of a CBDC account and the transaction details of one or more Empty Cards linked to the CBDC account are provided to a user terminal by the bank server for a transaction detail confirmation request received through the user terminal in the capacity of an account holder of the CBDC account linked to the Empty Card, and only the transaction details of the Empty Cards are provided to the user terminal by the bank server for the transaction detail confirmation request received through the user terminal in the capacity of a card user of the Empty Card.

The operation method of the empty self-control card system according to the exemplary embodiment may further include: aggregating, by the bank server, expenses, wherein expense details are automatically aggregated and provided to a user terminal on the basis of transaction details of a CBDC account and transaction details of one or more Empty Cards linked to the CBDC account for a tax processing request received through the user terminal in the capacity of an account holder of the CBDC account linked to the Empty Card.

The features and advantages of the present disclosure will become more apparent from the following detailed description based on the accompanying drawings.

Prior to this, the terms or words used in the present disclosure and claims are not to be construed to their ordinary and dictionary meanings, and should be interpreted as meanings and concepts corresponding to the technical spirit of the present disclosure based on the principle that inventors may properly define the concept of a term in order to best describe their disclosure.

### BRIEF DESCRIPTION OF THE DRAWINGS

FIG. 1 is a view illustrating an empty self-control card system according to an exemplary embodiment.

FIG. 2 is a view illustrating currency exchanges between dollars and coins according to the exemplary embodiment.

FIG. 3 is a view illustrating issuance of an Empty Card according to the exemplary embodiment.

FIG. 4 is a view illustrating issuance of an Empty Card according to another exemplary embodiment.

FIG. 5 is a view illustrating a connection between an account and the Empty Card according to the exemplary embodiment.

FIG. 6 is a view illustrating payment using the Empty Card according to the exemplary embodiment.

FIG. 7 is a view illustrating payment using an Empty Card according to another exemplary embodiment.

FIG. 8 is a view illustrating that an Empty Card 30 is compared with other cards according to the exemplary embodiment.

FIG. 9 is a view illustrating transactions using the Empty Card according to the exemplary embodiment.

FIG. 10 is a view illustrating a transaction using the Empty Card abroad according to the exemplary embodiment.

FIG. 11 is a view illustrating a tax process according to the exemplary embodiment.

### DETAILED DESCRIPTION OF THE INVENTION

Objectives, advantages, and features of the present disclosure will become more apparent from the following detailed description taken in conjunction with the accompanying drawings and preferred embodiments, but the present disclosure is not necessarily limited thereto. In addition, in describing the present disclosure, when it is determined that a detailed description of a related known technology may unnecessarily obscure the subject matter of the present disclosure, the detailed description thereof will be omitted.

In assigning reference numerals to components of the drawings, it should be noted that the same components are given the same reference numerals as much as possible even when they are shown in different drawings, and similar reference numerals are given to similar components.

The terminology used to describe exemplary embodiments of the present disclosure is not intended to limit the present disclosure. It should be noted that expressions in singular may include a plurality of expressions unless the context clearly indicates otherwise.

In this document, expressions such as “has”, “may have”, “comprises”, “may comprise”, “includes”, or “may include” refer to the corresponding characteristic (e.g., a numerical value, function, operation, or component such as a part), and does not exclude the presence of additional characteristics.

Terms such as “one”, “other”, “another”, “first”, “second”, etc. are used to distinguish one component from another, and components are not limited by the above terms.

The exemplary embodiments described in the present document and the accompanying drawings are not intended to limit the present disclosure to specific exemplary embodiments. It should be understood that the present disclosure includes various modifications, equivalents, and/or alternatives of the exemplary embodiments.

Hereinafter, exemplary embodiments of the present disclosure will be described in detail with reference to the accompanying drawings.

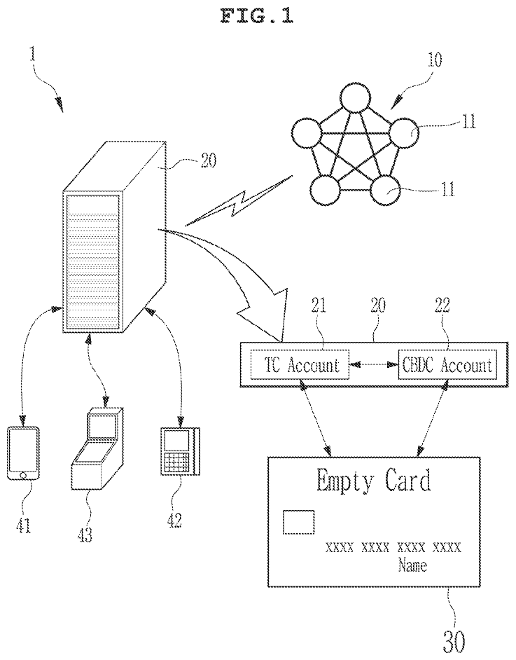

FIG. 1 is a view illustrating an empty self-control card system 1 according to an exemplary embodiment.

An empty self-control card system 1 according to the exemplary embodiment of the present disclosure may include: a bank server 20 communicatively connected to a CBDC network 10 and configured to open a CBDC account 22 for storing CBDC coins; and an Empty Card 30 linked to the CBDC account 22 and issued as a physical card, and configured to hold the CBDC coins as a balance, wherein the CBDC network 10 may transfer at least a portion of the balance of the Empty Card 30 when a transaction using the Empty Card 30 occurs.

The central bank digital currency (CBDC) is currency issued by a central bank of a country. The unit of CBDC may have various names, but in the present document, the unit of CBDC is referred to as a coin ( [symbol] ). CBDC may be traded in units of 1 coin, and may be divided and traded like 0.01 coin or 0.0001 coin. 1 coin may have the same value as 1 dollar ( [symbol] ), which is a traditional currency (TC). However, it may be decided that a value of 1 coin is different from that of the traditional currency of 1 dollar.

The CBDC may be operated on the basis of the CBDC network 10. The CBDC network 10 is a distributed ledger configured to store CBDC transaction information. The CBDC network 10 may be a private blockchain network including nodes 11 operated by a predetermined organization.

The nodes 11 of the CBDC network 10 may store transaction information of CBDC. Each of the nodes 11 may include a computer device capable of processing, transmitting, and recording data. Each node 11 may include a processor, a storage unit communicatively connected to the processor, and a network communication unit communicatively connected to the processor. The processor of each node 11 reads and executes program codes stored in the storage unit, thereby enabling each node 11 of the CBDC network 10 to perform functions. The program codes stored in the storage unit of each node 11 may be written to perform functions of the CBDC network 10, to distribute and store transaction details of CBDC coins, and to include various smart contracts. The network communication unit of the CBDC network 10 may be connected to a network by wire or wirelessly to transmit/receive data to and from a bank server 20, a user terminal 41, a store terminal 42, an ATM 43, and the like.

The nodes 11 of the CBDC network 10 may perform and record transactions using CBDCs, remittances, currency exchanges between CBDCs and TCs, currency exchanges between CBDCs and the central bank digital currencies or traditional currencies of other countries, and the like. The CBDC network 10 may be connected to enable data communication with a bank server 20, a CBDC network 10 of another country, a user terminal 41, a store terminal 42, an ATM 43, and other devices using various CBDCs.

In the present document, a bank is a concept that encompasses institutions that store customer funds, invest on behalf of customers, or perform loans. The bank server 20 is a server operated by each bank other than a central bank that issues CBDC. For example, the bank server 20 may be operated by an institution or a company, such as an investment bank, an insurance company, a trust company, or the like, that opens accounts to store customer's funds, invests on behalf of customers, or performs loans.

The bank server 20 may include a computer device capable of transmitting and receiving data with the user terminal 41 and the CBDC network 10. The bank server 20 may include a processor, a storage unit communicatively connected to the processor, and a network communication unit communicatively connected to the processor. The processor of the bank server 20 may perform functions of the bank server 20 by reading and executing program codes stored in the storage unit. The program codes stored in the storage unit of the bank server 20 may be written to perform the functions of the bank server 20, store the CBDC account 22 and the transaction details of the Empty Card 30 linked to the CBDC account 22, and communicate with the user terminal 41 to confirm various transaction details, to issue an Empty Card 30, and the like. The network communication unit of the bank server 20 may be connected to a network by wire or wirelessly to transmit/receive data to and from the CBDC network 10, the user terminal 41, the store terminal 42, the ATM 43, and the like. The CBDC account 22 is a concept that includes an electronic wallet that may be connected to a blockchain network.

The bank server 20 may be one of a plurality of nodes 11 constituting the CBDC network 10. The bank server 20 may open a TC account 21 or a CBDC account 22 according to a request of the user terminal 41. The TC account 21 is an account for depositing and withdrawing traditional currencies. The CBDC account 22 is an account for depositing and withdrawing CBDCs.

The bank server 20 may exchange dollars of the TC account 21 into coins and transfer the coins to the CBDC account 22. Conversely, the bank server 20 may exchange the coins of the CBDC account 22 into dollars and transfer the dollars to the TC account 21. The bank server 20 may transfer the coins of the CBDC account 22 to another CBDC account 22. The bank server 20 may exchange and transfer CBDC of a specific country into TC or CBDC of another country. The exchange and remittance of the TC or CBDC by the bank server 20 may proceed according to a request of the user terminal 41.

The user terminal 41 is a computer device used by an account holder 51 or a card user 52 using an Empty Card 30 in order to connect to the bank server 20. The account holder 51 is a person who owns a CBDC account 22. The card user 52 is a person who uses the Empty Card 30. The account holder 51 and the card user 52 may be the same person. The card user 52 may be someone other than the account holder 51. The account holder 51 or the card user 52 of the Empty Card 30 may be collectively referral to as a user. The account holder 51 or the card user 52 may connect to the bank server 20 through the user terminal 41.

The user terminal 41 may include a PC, a notebook PC, a smart phone, a tablet PC, a PDA, and other information processing devices. The user terminal 41 may include a processor, a storage unit communicatively connected to the processor, a network communication unit communicatively connected to the processor, and a touch display for providing information to a user and receiving a user's input. The processor of the user terminal 41 reads and executes program codes stored in the storage unit, thereby enabling the user terminal 41 to perform functions. The program codes stored in the storage unit of the user terminal 41 may be an application downloadable from the bank server 20. The network communication unit of the user terminal 41 may be connected to a network by wire or wirelessly to transmit/receive data to and from the CBDC network 10, bank server 20, store terminal 42, ATM 43, and the like.

The user may connect to the bank server 20 through an application installed in the user terminal 41 and configured to connect to the bank server 20. The application may be written as program codes that perform functions of connecting to the bank server 20, requesting issuance of an Empty Card 30, performing registration of the Empty Card 30, and stopping use, remitting money, processing tax, confirming transaction history, and other various functions of the Empty Card 30. The user may connect to the bank server 20 by inputting information capable of proving an individual's identity. The information capable of proving the individual's identity may include information on an ID, a password, a pattern, a fingerprint, an iris, and other information enabling function of identifying the individual identity to be performed.

The Empty Self-control Card 30 is a means necessary to use CBDC. In present document, the Empty Self-control Card 30 may be abbreviated as an “Empty Card 30”. The Empty Self-control Card 30 may be referral to as an “ESC Card”. The term “Self-Control” means “Self-Managed”. This means that the account holder can manage the “Empty Card!” on his own without the permission of the bank.

Unlike TC, a tangible CBDC does not really exist. For example, there is a real one dollar bill for TC 1 dollar. However, 1 coin of CBDC does not exist as a real thing. Accordingly, in order to use CBDC, a means for using the CBDC in the real world is required, and the present disclosure proposes the Empty Card 30 as the means. The account holder 51 may transfer coins of a CBDC account 22 to the Empty Card 30 by using the user terminal 41, or exchange dollars of a TC account 21 into coins and transfer the coins to the Empty Card 30. The account holder 51 may transfer dollars of the TC account 21 to the Empty Card 30 by using the user terminal 41. The Empty Card 30 may have a coin balance or a dollar balance. While carrying the Empty Card 30, the card user 52 may pay with coins or dollars at a store, or may withdraw dollars from an ATM 43.

A store terminal 42 may read an Empty Card 30 possessed by a user and proceed with payment. An ATM 43 reads a user's Empty Card 30 to provide a dollar bill requested by a user. The store terminal 42 and the ATM 43 are connected to the bank server 20 to claim coins or dollars held by the Empty Card 30. The bank server 20 may transfer a portion of the coins or dollars held by the Empty Card 30 to an account of the store or an account of the ATM 43 upon request. The account of the store or the account of the ATM 43 may be an account opened in the bank server 20 or another bank.

As described above, intangible CBDC coins may be used for payment by using the Empty Card 30, and a balance of CBDC coins may be withdrawn in dollars. Since the CBDC network 10 is also connected to CBDC networks 10 of other countries, the user may use the Empty Card 30 to make payments at stores in other countries or withdraw TC bills from other countries. The empty self-control card system 1 for performing such functions will be specifically described below.

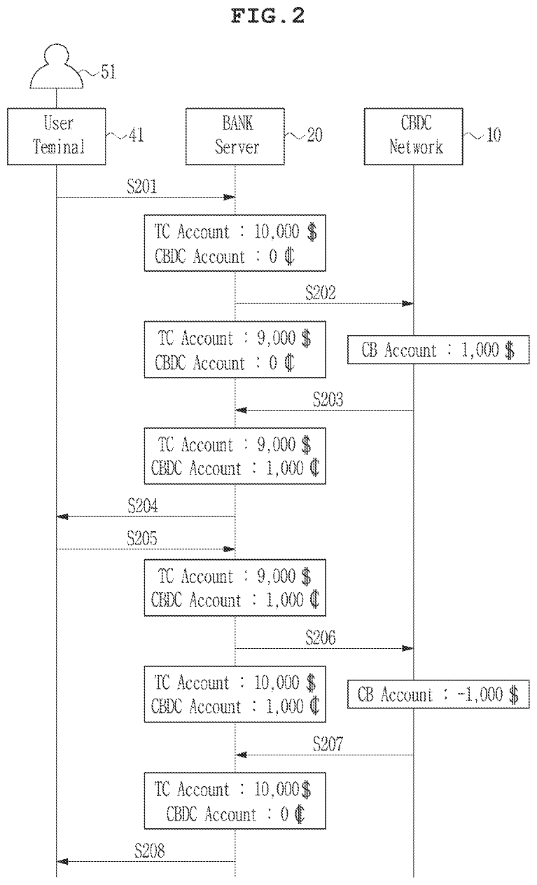

FIG. 2 is a view illustrating currency exchanges between dollars and coins according to the exemplary embodiment. For simplicity in all drawings in the present document, a coin is denoted by [symbol] , a dollar is denoted by [symbol] , and Korean won is denoted by [symbol] .

In step S201, by using a user terminal 41, an account holder 51 requests a bank server 20 to exchange 1,000 coins for 1,000 dollars. An exchange rate between dollars and coins assumes that 1 dollar is 1 coin, so it is unnecessary to calculate the exchange rate. However, when there is a predetermined exchange rate, the user terminal 41 may automatically calculate coins corresponding to the input dollars or dollars corresponding to the input coins.

When the user terminal 41 requests the bank server 20 to exchange money in step S201, the bank server 20 confirms the existence of a dollar balance in a TC account 21 of the account holder 51. Since 10,000 dollars exist in the TC account 21 shown in FIG. 2, the 1,000 dollars may be exchangeable.

When the bank server 20 transmits a transaction requesting the exchange of 1,000 dollars for 1,000 coins to a CBDC network 10 in step S202, a first currency exchange smart contract operates in the CBDC network 10. The first currency exchange smart contract creates an arbitrary central bank account (i.e., a CB account) in the CBDC network 10 and transmits the account to the bank server 20, and the bank server 20 transfers 1,000 dollars from the TC account 21 of the account holder 51 to the designated central bank account

When information that the deposit of 1,000 dollars in the central bank account is input to the first currency exchange smart contract, the first currency exchange smart contract operates to deposit 1,000 coins in the CBDC account 22 in step S203.

In step S204, the bank server 20 may transmit to the user terminal 41 that the balance of the TC account 21 becomes 9,000 dollars and the balance of the CBDC account 22 becomes 1,000 coins.

Coins in the CBDC account 22 may be exchanged into dollars and deposited in the TC account 21. In step S205, by using the user terminal 41, the account holder 51 requests the bank server 20 to exchange 1,000 dollars into 1,000 coins.

When the user terminal 41 requests the bank server 20 to exchange money in step S205, the bank server 20 confirms the existence of a coin balance in the CBDC account 22 of the account holder 51. Since 1,000 coins exist in the CBDC account 22 shown in FIG. 2, 1,000 coins may be exchangeable.

When the bank server 20 transmits a transaction requesting the exchange of 1,000 coins for 1,000 dollars to the CBDC network 10 in step S206, a second currency exchange smart contract operates in the CBDC network 10. The second currency exchange smart contract transfers 1,000 dollars from the central bank account (i.e., the CB account) that stores dollars of the CBDC network 10 to the TC account 21 of the account holder 51.

When information that the deposit of 1,000 dollars in the TC account 21 of the account holder 51 is input to the second currency exchange smart contract, the second currency exchange smart contract operates to withdraw 1,000 coins from the CBDC account 22 in step S207.

In step S208, the bank server 20 may transmit to the user terminal 41 that the balance of the TC account 21 becomes 10,000 dollars and the balance of the CBDC account 22 becomes 0 coins.

As described above, the CBDC network 10 may execute the first and second currency exchange smart contracts. The first and second currency exchange smart contracts are a kind of smart contracts that operates in a blockchain environment. The first and second currency exchange smart contracts start to operate when a currency exchange request is input, and may be written to perform remittance of CBDC on condition of deposit or withdrawal of TC.

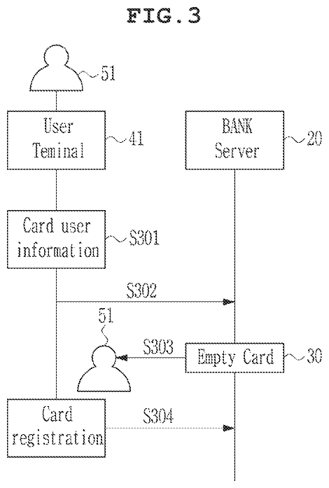

FIG. 3 is a view illustrating issuance of an Empty Card 30 according to the exemplary embodiment.

An Empty Card 30 is issued as a physical card (see a reference numeral 30 in FIG. 1) including a card number and a name in response to an issuance request of the account holder 51, and the name included in the Empty Card 30 is a name of a card user 52 who uses the Empty Card 30, and the card user 52 may be the same as or different from the account holder 51. The bank server 20 does not perform examination on whether the Empty Card 30 is issued to a person whose name is included in the Empty Card 30, but only confirms the Empty Card 30 issuance qualifications of the account holder 51 and determines to issue the Empty Card 30.

An operation method of an empty self-control card system may include: receiving, by a bank server 20, an issuance request of an Empty Card 30 linked to a CBDC account 22 of an account holder 51 from a user terminal 41; and determining, by the bank server 20, issuance of the Empty Card 30 by examining only whether the account holder 51 is entitled to issue the Empty Card 30 without examining a name written in card user information included in the issuance request.

The account holder 51 generates card user information through the user terminal 41 in step S301. The card user information may include information of a person who will use the card. The card user information may further include other information in addition to the name. However, it is sufficient when the card user information includes the name of the person who will use the card. For example, when the account holder 51 applies for a card to be used by himself or herself, the card user information may include only the name of the account holder 51. This is because the bank server 20 does not examine whether the Empty Card 30 is issued to the person whose name is included in the card user information.

In step S302, the account holder 51 transmits the card user information to the bank server 20 through the user terminal 41 and requests card issuance. The bank server 20 receiving a card issuance request determines to issue an Empty Card 30 at the responsibility of the account holder 51. The responsibility of the account holder 51 means that the bank server 20 does not consider an age, a balance, credit, and the like of a person with the name included in the card user information, and issues the Empty Card 30 when the account holder 51 is entitled to issue the Empty Card 30.

As shown in FIG. 1, the Empty Card 30 issued by the bank as a physical card may display a card number and a name.

In step S303, the bank may produce the physical Empty Card 30 and deliver the Empty Card 30 to the person (here, the account holder 51) with the name written in the card user information. The Empty Card 30 may be delivered by mail or personal delivery.

When the person who will use the card is the account holder 51, the account holder 51 may register the Empty Card 30 in step S304. The card registration in step S304 may be performed by way of inputting information required for the card registration through the user terminal 41 and providing the information to the bank server 20. Once the card registration is completed, the card may be used.

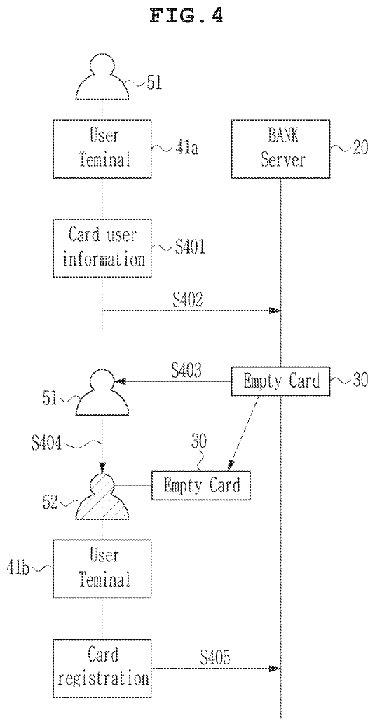

FIG. 4 is a view illustrating issuance of an Empty Card 30 according to another exemplary embodiment

An Empty Card 30 may be issued for use by other people other than the account holder 51. Even when there is only one CBDC account 22 owned by the account holder 51, the account holder 51 may issue a plurality of Empty Cards 30. The account holder 51 may issue the Empty Cards 30 for the purpose of allowing other people to use the Empty Cards 30. Since the Empty Cards 30 use respective balances remitted by the account holder 51 to the Empty Cards 30, there is no damage to the bank even when the account holder 51 issues the plurality of Empty Cards 30.

In step S401, the account holder 51 generates card user information through the user terminal 41. The account holder 51 may write a name of a person other than himself/herself in the card user information. The account holder 51 may be an individual or a corporation. In the card user information, the account holder 51 may write a name of a family member or an employee, who will actually use the card. That is, on his or her own responsibility, the account holder 51 may write the name of the person to whom the card is to be assigned in the card user information.

In step S402, when the account holder 51 transmits the card user information to the bank server 20, card issuance is requested. The bank server 20 that receives a card issuance request issues an Empty Card 30 at the responsibility of the account holder 51. The bank server 20 does not consider credit, an age, an account balance, and the like of the person written in the card user information. The bank server 20 confirms whether the account holder 51 who has requested the card issuance is entitled to issue the Empty Card 30, and issues the card with the name written in the card user information. In this case, the name written in a name section of the Empty Card 30 of FIG. 1 is the name written in the information of the card user as the person who will actually use the card.

In step S403, the bank server 20 may produce a physical Empty Card 30 and deliver the Empty Card 30 to the account holder 51. In step S404, the account holder 51 may deliver the Empty Card 30 to the person who will actually use the card. The account holder 51 may further write an address of a card user 52 as an address to receive a physical card in the card user information, and the bank may directly deliver the physical Empty Card to the card user 52 (refer to the dotted arrow in FIG. 4).

In step S405, the card user 52 may register the Empty Card 30. In this case, the card user 52 is not the account holder 51. In step S405, the card user 52 may perform card registration through his or her user terminal 41. When the card registration is performed, the card user 52 may use coins in a range of a balance of the Empty Card for transactions.

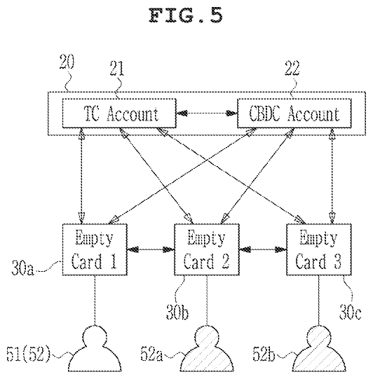

FIG. 5 is a view illustrating a connection between an account and the Empty Card 30 according to the exemplary embodiment.

One or more Empty Card 30 are issued and linked to a CBDC account 22 of an account holder 51, and a card user 52 may be authorized to perform transactions in a range of a balance transferred to the Empty Card 30.

The account holder 51 may issue one or more Empty Cards 30. A plurality of Empty Cards 30 may be linked to the CBDC account 22 of the account holder 51. The account holder 51 may use an Empty Card 1 (30a) for himself or herself, and allow other people to use an Empty Card 2 (30b) and an Empty Card 3 (30c). The account holder 51 is also the card user 52 using the Empty Card 1 (30a). In this case, not the account holder 51 but the card users 52a and 52b who use the respective cards are authorized to perform transactions within a range of the balance held in the Empty Card 30 by remittance to the Empty Card 30 by the account holder 51. The bank server 20 allows payment in the range of the balance of the Empty Card 30, but rejects a case of receiving a request of a transaction exceeding the balance of the Empty Card 30.

When the account holder 51 connects to the bank server 20 through the user terminal 41, the bank server 20 may provide a function of managing a CBDC account 22 and one or more Empty Cards 30a, 30b, and 30c linked to the CBDC account 22. When the card users 52b and 52c connect to the bank server 20 through respective user terminals 41, the bank server 20 provides a function to manage the empty cards 30b and 30c, which are respectively issued in the name of the card users 52b and 52c, and does not provide a function to access the CBDC account 22. The management functions provided to the account holder 51 may include remitting money, confirming transaction history, and issuing, registering, stopping use, processing tax, and other functions of the Empty Cards. The management functions provided to the card users 52b and 52c may include the remittance, transaction history confirmation, registration of Empty Cards 30b and 30c, and other functions, and are valid only for the Empty Cards 30b and 30c, which are respectively registered in names of the card users 52b and 52c. For example, the card user 52b may only perform transactions using the Empty Card 2 (30b), and the card user 52c may only perform transactions using the Empty Card 3 (30c).

When the account holder 51 connects to the bank server 20 through the user terminal 41, the bank server 20 may provide functions of transferring coins of the CBDC account 22 to the Empty Card 30 and recovering a balance of the coins of the Empty Card 30 to the CBDC account 22.

The account holder 51 may transfer money between an account and the Empty Card 30 using the user terminal 41. The account holder 51 may transfer money by exchanging dollars of the TC account 21 and coins of the CBDC account 22 with each other. The account holder 51 may transfer coins to the Empty Card 30 issued on his or her own responsibility. The account holder 51 may transfer a portion of a coin balance of the CBDC account 22 to the Empty Card 30, and may exchange a portion of a dollar balance of the TC account 21 into coins and transfer the coins to the Empty Card 30. The account holder 51 may transfer the coins stored in the Empty Card 30 issued on his or her own responsibility to another Empty Card 30, or may transfer the coins back to the CBDC account 22.

For example, the account holder 51 may issue three Empty Cards 30, including an Empty Card 1 (30a) for his or her own use, an Empty Card 2 (30b) for his or her mother to use, and an Empty Card 3 (30c) for his or her child to use. The account holder 51 may transfer a portion of coins of his or her CBDC account 22 to the Empty Card 2 (30b) of his or her mother through the user terminal 41. When his or her child loses the Empty Card 3 (30c), the account holder 51 may recover the balance transferred to the Empty Card 3 (30c) lost by the child back to the CBDC account 22. Apart from the stopping use of the Empty Card 3 (30c) lost by the child, the account holder 51 may recover the coin balance of the lost Empty Card 3 (30c). In a case of a prepaid card, when the card is lost, the money stored in the card is also lost. However, according to the present disclosure, the account holder 51 may transfer the balance of the Empty Card 30 back to the CBDC account 22, so the money may not be lost

In summary, the account holder 51 may confirm a balance of all the Empty Cards 30 issued on his or her own responsibility, and transfer a portion of the balance. That is, the account holder 51 may play the same role as a conventional bank for all the Empty Cards 30 issued on his or her own responsibility. The Empty Self-control Card 30 is referred to as “Empty” because a blank (i.e., empty) card may be used by transferring coins thereto, and is referral to as a “self-control” card because the account holder 51 may directly control the Empty Card without approval from a bank.

The card users 52a and 52b, rather than the account holder 51, may transfer the balances of the respective Empty Cards 30b and 30c used by themselves by using the respective user terminals 41. The card users 52a and 52b, rather than the account holder 51, have respective authorities to remit, settle, and withdraw only the respective balances of the Empty Cards 30b and 30c. When connecting to a bank server 20 by using the respective user terminals 41, the card users 52a and 52b, rather than the account holder 51, may confirm the respective balances of the empty cards 30b and 30c registered by themselves. The card users 52a and 52b, who are not the account holder 51, may respectively transfer portions of the balances of the empty cards 30b and 30c registered by themselves to the TC account 21 and the CBDC account 22 of the account holder 51, the Empty Card 30 that is under the responsibility of the account holder 51, another bank account, or other people's accounts.

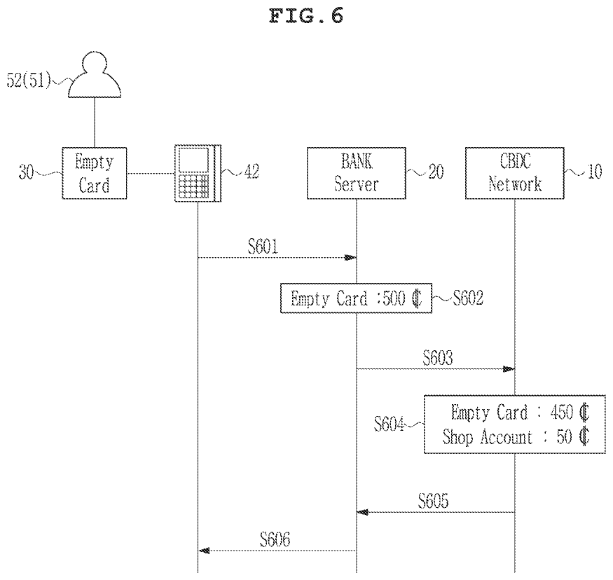

FIG. 6 is a view illustrating payment using the Empty Card 30 according to the exemplary embodiment. FIG. 1 will be referred together.

The operation method of the empty self-control card system may include: receiving, by a bank server 20, a transaction request using an Empty Card 30 a balance of CBDC coins; confirming, by the bank server 20, whether the balance required for a transaction exists in the Empty Card 30; requesting, by the bank server 20, to a CBDC network 10 to transfer a portion of the balance existing in the Empty Card 30; and transferring the coins by the CBDC network 10.

A transaction request received by the bank server 20 may be received from any one of devices including: a store terminal 42 configured to read an Empty Card 30 and request payment; an ATM 43 configured to request a cash-out using the Empty Card 30; a user terminal 41 configured to request a remittance of a portion of the balance in the capacity of a card user 52 of the Empty Card 30; and a user terminal 41 configured to request a remittance of a portion of the balance of the Empty Card 30 in the capacity of an account holder 51 of a CBDC account 22 linked to the Empty Card 30.

The transaction request transmitted to the bank server 20 by the store terminal 42 is to request payment using the Empty Card 30. The transaction request transmitted to the bank server 20 by the ATM 43 may include requesting a cash-out of a portion of the balance of the Empty Card 30, or transferring a portion of the balance of the Empty Card 30 in the capacity of the card user 52. The transaction request transmitted to the bank server 20 by the user terminal 41 may include: requesting remittance of a portion of the balance of the Empty Card 30 in the capacity of the account holder 51 of an account linked to the Empty Card 30; and requesting remittance of a portion of the balance of the Empty Card 30 in the capacity of the card user 52 of the Empty Card 30.

The bank server 20 receiving the transaction request performs a process of transferring coins according to the transaction details. Representatively, a process of dealing with a transaction request received from the store terminal 42 will be described.

An Empty Card 30 holds a coin balance. A payment operation may be different depending on whether a payment currency of a store is dollars or coins.

First, a case where the payment currency requested by the store is coins will be described. When a user inserts an Empty Card 30 into a store terminal 42, the store terminal 42 reads the Empty Card 30 and requests coins according to a payment amount to a bank server 20, and the bank server 20 may receive a request of transactions using the Empty Card 30 in step S601. For example, the store terminal 42 may request a payment amount of 50 coins.

In step S602, the bank server 20 confirms whether a balance of the Empty Card 30 is sufficient to pay the requested coins. For example, since the balance of the Empty Card 30 is 500 coins, the balance is sufficient to pay the 50 coins. When the balance of the Empty Card 30 is not sufficient to pay the requested coins, the bank server 20 may notify the store terminal 42 that the payment is unable to be completed.

When the balance is sufficient, the bank server 20 may transmit a transaction that requests a CBDC network 10 to transfer a portion of the balance of the Empty Card 30 to a shop account in step S603. In this case, since the store terminal 42 requested the coins, a store account where the store will receive the coins is a CBDC account 22.

In step S604, the CBDC network 10 may transfer the requested coins from the balance of the Empty Card 30 to the CBDC account 22 owned by the store. For example, as a result of transferring 50 coins from the Empty Card 30 to the store account, the balance of the Empty Card 30 becomes 450 coins, and the balance of the store account may be increased by 50 coins. In step S605, the CBDC network 10 may notify the bank server 20 that the payment has been completed. In step S606, the bank server 20 may provide a notification that the payment has been completed to the store terminal 42.

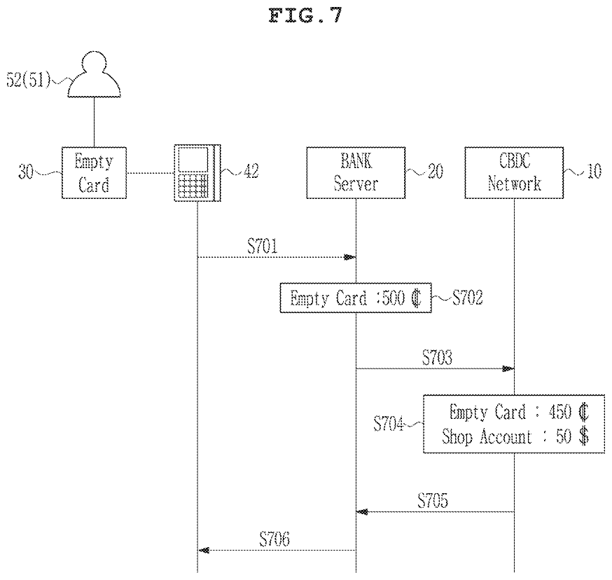

FIG. 7 is a view illustrating payment using an Empty Card 30 according to another exemplary embodiment.

A case where a payment currency of a store is dollars will be described. When a user inserts an Empty Card 30 into a store terminal 42, the store terminal 42 reads the Empty Card 30 and requests dollars according to a payment amount to a bank server 20, and the bank server 20 may receive a request of transactions using the Empty Card 30 in step S701. For example, the store terminal 42 may request a payment amount of 50 dollars.

In step S702, the bank server 20 confirms whether a balance of the Empty Card 30 is sufficient to pay the requested dollars. For example, since the balance of the Empty Card 30 is 500 coins, it is sufficient to pay with 50 dollars. Since coins and dollars may be exchanged one to one, the bank server 20 may automatically convert and compare the balance. When the balance of the Empty Card 30 is not sufficient to pay the requested dollars, the bank server 20 may notify the store terminal 42 that the payment is unable to be completed.

When the balance is sufficient, the bank server 20 may transmit a transaction that requests a CBDC network 10 to exchange a portion of the balance of the Empty Card 30 into dollars and transfer the dollars to a shop account in step S603. In this case, since the store terminal 42 requested the dollars, a store account where the store will receive the dollars is a TC account 21.

The CBDC network 10 may operate a second currency exchange smart contract. The second currency exchange smart contract transfers 50 dollars from a central bank account (CB account) that stores dollars of the CBDC network 10 to the store account. When information that the deposit of 50 dollars in the store account is input to the second currency exchange smart contract, the second currency exchange smart contract operates to withdraw 50 coins of the Empty Card 30 in step S704. For example, as a result of exchanging 50 coins into 50 dollars on the Empty Card 30 and transferring the money to the store account, the balance of the Empty Card 30 becomes 450 coins, and the store account may increase by 50 dollars. In step S705, the CBDC network 10 may notify the bank server 20 that the payment has been completed. In step S706, the bank server 20 may provide that the payment is completed to the store terminal 42.

Similar to the payment requested by the store terminal 42, even in the cases of a cash-out requested by the ATM 43, a remittance requested by the account holder 51, and a remittance requested by the card user 52, when the bank receives such transaction requests, the embodiment of the present disclosure may perform processes of confirming the balance of the Empty Card 30, requesting a remittance of coins to the CBDC network 10, and performing the remittance by the CBDC network 10.

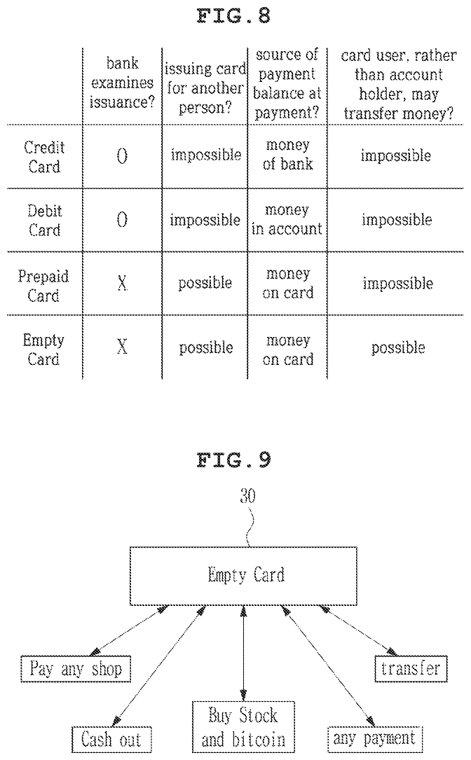

FIG. 8 is a view illustrating that an Empty Card 30 is compared with other cards according to the exemplary embodiment.

The Empty Card 30 is a novel card different from the conventional credit card, debit card, and prepaid card. The Empty Card 30 is different from other cards in that the responsibility for issuance rests with an account holder 51 and a bank does not examine whether an Empty Card is issued. The Empty Card 30 is different from other cards in that the account holder 51 applying for issuance is capable of issuing the Empty Card for use by a card user 52 who is another person. The Empty Card 30 is different from other cards in that payment is completed in a way that a balance of the card is transferred immediately. The Empty Card 30 is different in that the card user 52, rather than the account holder 51, may perform a remittance within a balance range of the Empty Card 30. The Empty Card 30 is different from other cards in that the account holder 51 is capable of recovering the balance of the card back to an account.

A credit card and an Empty Card 30 will be compared with each other.

For the issuance of a credit card, a bank evaluates user's credit and determines whether to issue the credit card. In contrast, in the issuance of an Empty Card 30, when the account holder 51 only applies the issuance of the Empty Card under the responsibility of the account holder 51, the bank issues the card. In the issuance process of the Empty Card 30, the bank simply issues a physical card and serves to deliver the physical card to the account holder 51. The bank does not evaluate credit of a card user 52, but only determines whether the account holder 51 is entitled to issue the Empty Card 30.

In general, a credit card issuance applicant is unable to issue a card for use by another person. Since the credit card is issued in the name of the credit card issuance applicant, the credit card may not be used by another person. In addition, in a case where the credit card to be used by another person is issued on the basis of the credit of the credit card issuance applicant, since the credit card has a structure in which the credit card issuance applicant is responsible for the use by another person, there is a high possibility of problems occurring. In a case where a credit card is issued on the basis of credit of a person who uses the credit card, the person using the credit card only needs to apply for the credit card, so there is no reason for others to apply for the issuance. In contrast, in an Empty Card 30, the Empty Card 30 may be issued for the card user 52 whose account holder 51 is not himself or herself. The account holder 51 may issue the Empty Card 30 in the name of the card user 52, so as to transfer the Empty Card 30 to the card user 52. The person who requested the issuance is the account holder 51 and the person who uses the Empty Card 30 is the card user 52, and thus the account holder 51 and the card user 52 may be different from each other. Since the Empty Card 30 is proceeded with transactions within a balance range assigned to the card, there is no problem that the account holder 51 is held responsible for a limit-exceeding transaction made by the card user 52.

For credit cards, a bank sets a limit according to user's credit. When payment is made, a credit card is operated in a business flow where a bank pays first, and a user pays the bank later. That is, the credit card uses money from the bank. Accordingly, a credit card does not have a balance, but has a credit limit, so a function of remittance of a portion of the limit of the credit card is not supported. In contrast, the limit of an Empty Card 30 is not determined according to credit of a card user 52. In the Empty Card 30, the account holder 51 transfers money to the Empty Card 30 to perform transactions within a range of a balance held by the Empty Card 30. That is, the Empty Card 30 uses the balance held by the Empty Card 30, not the money of the bank that has issued the Empty Card 30. Accordingly, the card user 52 of the Empty Card 30 may transfer money within the range of the balance of the Empty Card 30.

Since the credit card is given a credit-based limit on the credit card itself, a concept that a credit card issuer recovers a credit card limit does not exist. When a credit card is lost, the card issuer will only stop the use of the card. In contrast, the account holder 51 may recover a balance of the Empty Card 30 back to an account. When the Empty Card 30 is lost, the balance of the Empty Card 30 may be transferred back to the account, separately from stopping the use of the Empty Card 30. Even when the card user 52 of the Empty Card 30 is a different person from the account holder 51, the account holder 51 may transfer the balance of the Empty Card 30 to an account, and the card user 52 may also transfer the balance of the Empty Card 30 to an account.

A debit card and an Empty Card 30 will be compared with each other.

The debit card is a card linked to a bank account. Accordingly, when a bank issues the debit card, the debit card is issued in the name of an account holder 51. In order to issue a debit card in the name of another person other than the account holder 51, another person should be added as an account holder. Changing the account to a jointly owned account requires examination by a bank. That is, in the debit card, a bank does not issue a card for use by another person other than the account holder 51. This is because when the debit card is used, a balance of the account is deducted. In contrast, when issuing an Empty Card 30, the bank does not examine whether the name of the account holder 51 and the name of the card user 52 are the same. When the account holder 51 who applied for an Empty Card 30 is entitled to issue the Empty Card 30, the bank issues the Empty Card 30 in the name of another person as well. The Empty Card 30 is deducted from a balance of the card, so a balance of the linked account is not deducted. Even when the card user 52, rather than the account holder 51, uses the Empty Card 30, since the card user 52 is unable to use the card more than the Empty Card 30 balance provided by the account holder 51, the account holder 51 may issue an Empty Card 30 to allow another person to use the card to a limit that the account holder 51 himself or herself may be held responsible.

When the debit card is used, a portion of the balance of a linked account is immediately transferred to a store's account. That is, the debit card uses the balance of the linked account. The debit card does not have a balance on the card itself. In contrast, the Empty Card 30 may perform transactions within a range of funds transferred by the account holder 51 to the Empty Card 30. That is, the Empty Card 30 uses the balance held by the Empty Card 30, not the balance of the account, which is linked to the Empty Card 30.

Since the debit card does not have a concept of a balance of a card, it is impossible for a person using the card to transfer a portion of the balance of the card. In contrast, the Empty Card 30 allows a card user to transfer a portion of a balance within a range of the balance of the card. The card user 52 has an authority to transact the balance of the Empty Card 30.

Since the debit card uses the balance of the account linked to the card, a concept that the credit card issuer recovers a balance does not exist. When a debit card is lost, the card issuer will only stop the use of the card. In a case where fraudulent use occurs while a debit card is lost, an amount of money is transferred from an account linked to the lost debit card . In contrast, the account holder 51 may recover a balance of the Empty Card 30 back to an account. When the Empty Card 30 is lost, the balance of the Empty Card 30 may be transferred back to the account separately from stopping the use of the Empty Card 30. When the fraudulent use occurs through the lost Empty Card 30, remittance occurs within a range of the balance of the Empty Card 30, but since the remittance does not occur from the balance of the account linked to the Empty Card 30, the Empty Card 30 is much safe. Even when the card user 52 of the Empty Card 30 is a person different from the account holder 51, the account holder 51 may transfer the balance of the Empty Card 30 to an account, and the card user 52 may also transfer the balance of the Empty Card 30 to the account

A prepaid card and an Empty Card 30 will be compared with each other.

The prepaid card is a card that is not related to a bank account. When a prepaid card is purchased or issued, a bank does not conduct examination related to credit. This is because the prepaid card uses a method in which a buyer charges his or her own money into the prepaid card, so as to use the money. A buyer's account and the prepaid card are not linked with each other. The buyer may add money to the prepaid card and make transactions within a range of the amount of the charged balance. In contrast, an Empty Card 30 is a card linked to an account holder 51 account opened in a bank. The Empty Card 30 is issued at the responsibility of the account holder 51, but since the prepaid card is not linked to a bank account, there is no concept that the buyer has any responsibility for the bank.

A buyer of the prepaid card may transfer a purchased prepaid card to another person. However, the buyer of the prepaid card does not have any management authority over the prepaid card transferred to another person. In contrast, the account holder 51 who has issued an Empty Card 30 has an authority to manage the Empty Card 30 owned by a card user 52, who is another person. The account holder 51 may stop the use of the Empty Card 30 issued on his or her own responsibility, transfer a balance, or recover the balance back to an account.

When a prepaid card is used, a portion of a balance of the card is transferred to a store's account immediately. The prepaid card is similar to the Empty Card 30 in that the balance of the card is used. However, the balance of the prepaid card exists in an account of a service provider that provides a prepaid card service, and interest and the like from the balance is owned by the service provider, and a balance of an Empty Card 30 is a balance linked to an account of a bank in which an account holder 51 has the account, so interest and the like on the balance is owned by the account holder 51, whereby there is a difference therebetween.

The prepaid card is similar to the Empty Card 30 in that transactions may be made within a range of the balance. However, a transaction of the prepaid card is for payment, and there is no remittance function. Even when the prepaid card has a remittance function, since a buyer and a user of the prepaid card are identical in principle, it is difficult to establish a concept that the user, rather than the buyer, performs remittance. In contrast, the Empty Card 30 is different in that a card user 52, not an account holder 51, may make payment or remittance within a balance range of the Empty Card 30.

In addition, when a prepaid card is lost, a card holder may not recover a balance. Since the prepaid card is not linked to a buyer's account, the balance stored in the prepaid card is also lost as soon as a buyer loses a physical prepaid card. In contrast, when an Empty Card 30 is lost, an account holder 51 may recover a balance of the Empty Card 30 in a way of transferring the balance back to a CBDC account 22, and the account holder 51 or the card user 52 may stop the use of the Empty Card 30. Since the Empty Card 30 is a bank-issued card linked to an account of the account holder 51 at the responsibility of the account holder 51, the account holder 51 may access a balance of the Empty Card 30 through the bank.

FIG. 9 is a view illustrating transactions using the Empty Card 30 according to the exemplary embodiment.

The Empty Card 30 may be used for various transactions. The Empty Card 30 may be used for payment in a store. The Empty Card 30 may be used to cash out TC dollars at a bank or an ATM 43. The Empty Card 30 may be used to purchase stocks or Bitcoins. The Empty Card 30 may be used in a store, Internet payment, tax payment, and other various payments. The Empty Card 30 may be used for remittance.

The card user 52 may transfer all or a portion of the balance of the Empty Card 30 to another Empty Card 30, his or her other account, or another person's account. A transaction using the Empty Card 30 may function in conjunction with a bank server 20 and a CBDC network 10. When a card user 52 uses the Empty Card 30, a store terminal 42, an ATM 43, or other terminal devices request a remittance to the bank server 20, so that the bank server 20 may transfer coins through the CBDC network 10.

Since transaction details using the Empty Card 30 are stored in the bank server 20, the card user 52 may confirm the transaction details of the Empty Card 30 through a user terminal 41. The account holder 51 may confirm the transaction details of all the Empty Cards 30 issued on his or her own responsibility through the user terminal 41.

The operation method of the empty self-control card system may further include: confirming, by the bank server 20, transaction details, wherein all the transaction details of a CBDC account 22 and the transaction details of one or more Empty Cards 30 linked to the CBDC account 22 are provided to a user terminal 41 by a bank server 20 for a transaction detail confirmation request received through the user terminal 41 in the capacity of an account holder 51 of the CBDC account 22 linked to the Empty Card 30, and only the transaction details of the Empty Card 30 are provided to the user terminal 41 for a transaction detail confirmation request received through the user terminal 41 in the capacity of a card user 52 of the Empty Card 30. The confirming of the transaction details may be performed whenever a user connects to the bank server 20 through the user terminal 41.

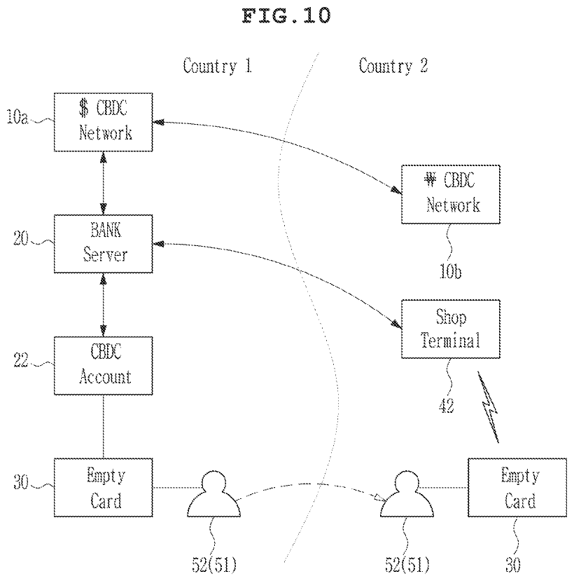

FIG. 10 is a view illustrating a transaction using the Empty Card 30 abroad according to the exemplary embodiment

A dollar ( [symbol] ) CBDC network 10a of a first country (i.e., country 1) and a Korean won ( [symbol] ) CBDC network 10b of a second country (i.e., country 2) may be connected to each other and operated according to an agreement therebetween. In the CBDC of the first country, 1 coin may be 1 dollar, and in the CBDC of the second country, 1 coin may be 1,000 Korean won. In addition, 1 coin of the first country and 1 coin of the second country may be linked in a one to one ratio or may be linked according to a set exchange rate.

An account holder 51 having a CBDC account 22 in a bank of the first country may receive an issued Empty Card 30. When the account holder 51 enters the second country with the Empty Card 30 (refer to the dotted arrow in FIG. 10), the account holder 51 may use the Empty Card 30 in the second country in the same way as using the Empty Card 30 in the first country. For example, when payment is made with the Empty Card 30 in a store, a store terminal 42 may request a payment amount to a bank server 20 of the first country, or may request the payment amount to the bank server 20 of the first country through a CBDC network 10b of the second country and a CBDC network 10a of the first country. When the bank server 20 of the first country confirms that an amount of money sufficient to pay the requested payment amount exists in the Empty Card 30, the bank server 20 may request currency exchanges and remittances to the CBDC network 10a of the first country and the CBDC network 10b of the second country.

In performing a remittance to an account opened in the bank of the second country, the account holder 51 who has the CBDC account 22 in the bank of the first country may immediately execute the remittance because the CBDC network 10a of the first country and the CBDC network 10b of the second country are connected and operated with each other. Conventionally, in order to transfer TC dollars from the first country to the second country, the bank of the first country performs a related procedure, and the money is transferred through an international payment network, whereby there is a problem that it takes one or more days for the money to be deposited into an account of the bank of the second country. In contrast, in the empty self-control card system 1, since the CBDC network 10a of the first country and the CBDC network 10b of the second country are connected to each other, coins may be transferred immediately.

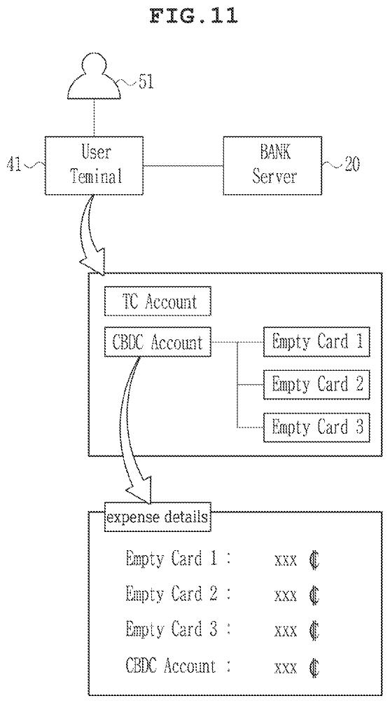

FIG. 11 is a view illustrating a tax process according to the exemplary embodiment. When an account holder 51 connects to a bank server 20 through a user terminal 41 and clicks a CBDC account 22, the account holder 51 may confirm all usage details of the Empty Card 30 linked to the CBDC account 22.

The operation method of the empty self-control card system may include: aggregating, by a bank server 20, expenses, wherein expense details are automatically aggregated and provided to a user terminal 41 on the basis of transaction details of a CBDC account 22 and transaction details of one or more Empty Cards 30 linked to the CBDC account 22 for a tax processing request received through the user terminal 41 in the capacity of an account holder 51 of the CBDC account 22 linked to the Empty Card 30.

The account holder 51 needs to aggregate expenses spent to pay tax. The account holder 51 may process usage details of the Empty Card 30 linked to his or her own account as his or her own expenses. The bank server 20 may provide a function of organizing expenses of a plurality of Empty Cards 30 as expenses of the CBDC account 22. Even when the plurality of Empty Cards 30 is issued, since the account holder 51 may confirm usage records of the plurality of Empty Cards 30 linked to the account through his or her user terminal 41, the account holder 51 may organize expenses in units of accounts without separately organizing each expense of the Empty Card 30. Unlike the prepaid card, since a balance of the Empty Card 30 is money of the account holder 51, the balance remaining in the Empty Card 30 is not included in expenses. The conventional credit card, debit card, and prepaid card are systems where each card is managed independently, so it is difficult to organize expenses. In contrast, since the Empty Card 30 has a structure in which the plurality of cards is linked to one account, there is provided convenience in which the account holder 51 may collectively organize the expenses of the Empty Card 30 linked to the CBDC account 22.

As described, the empty self-control card system 1 according to the present disclosure may provide a means for using CBDCs for transactions in real life. In addition, since coins are paid or transferred by using the CBDC network 10, the remittance between individuals, between companies and individuals, between companies, and between countries may be conveniently and quickly provided.

The present disclosure has been described in detail through specific exemplary embodiments. The exemplary embodiments are provided to specifically describe the present disclosure, but the present disclosure is not limited thereto. Within the technical spirit of the present disclosure, it will be apparent that modifications or improvements are possible by those skilled in the art.

All simple modifications or changes of the present disclosure fall within the scope of the present disclosure, and the specific scope of protection of the present disclosure will be made clear by the appended claims.

1.-11. (canceled)

12. A system for managing rechargeable devices, the system comprising:
a processor comprising physical hardware; and
a storage device storing program codes that, when executed by the processor, cause the processor to:
receive, from a first computing device associated with a first user account of a plurality of user accounts, a request to transmit a physical rechargeable device to a device user, wherein the request includes user information is indicative of an identity of the device user and additional information associated with the device user;
authorize, based on information associated with the first user account, the physical rechargeable device for transmission;
cause the physical rechargeable device to be transmitted to the device user indicated by the user information included in the request, wherein the physical rechargeable device holds an initial charge and is rechargeable upon a request from the first user account; and
output, to the first computing device, instructions to configure the first computing device to receive user input to a set of user-specific management functions associated with the physical rechargeable device, wherein the set of user-specific management functions includes disabling the physical rechargeable device registered with another user account and returning the physical rechargeable device from another user account to the first user account.

13. The system of claim 12, wherein the processor is further configured to:
receive, from the first user account, a request to disable further use of the physical rechargeable device; and
cause further use of the physical rechargeable device to be disabled based on the request being received from the first user account.

14. The system of claim 13, wherein the processor is further configured to:
subsequent to causing further use of the physical rechargeable device to be disabled, receive, from another user account, a request to use the physical rechargeable device; and
based on further use of the physical rechargeable device having been disabled at the request from the first user account, reject the request from said another account to use the physical rechargeable device.

15. The system of claim 12, wherein the processor is further configured to:
receive, from the first user account, a request to return the physical rechargeable device from a current user account to the first user account; and
cause the physical rechargeable device to be returned to the first user account and no longer associated with the current user account.

16. The system of claim 12, wherein the processor is further configured to:
receive a request to register the physical rechargeable device with a second user account associated with the device user; and
cause the physical rechargeable device to be registered with the second user account despite the second user account being different from the first user account.

17. The system of claim 12, wherein the processor is further configured to:
receive, from a second computing device associated with the device user, a request to register the physical rechargeable device; and
cause the physical rechargeable device to be registered with the device user despite the second computing device being different from the first user computing device associated with the first user account.

18. The system of claim 17, wherein the processor is further configured to output instructions to configure the second computing device to suppress at least one of the set of user-specific management functions from being provided to the device user based on the device user not being associated with the first user account.
